(19) United States
(12) Patent Application Publication
(10) Pub. No.: US 2024/0132774 A1
(43) Pub. Date: Apr. 25, 2024

(54) INJECTION AND HYDRAULIC FRACTURING FLUIDS CONTAINING ZWITTERIONIC SURFACTANTS AND RELATED METHODS

(71) Applicant: ExxonMobil Technology and Engineering Company, Spring, TX (US)

(72) Inventors: Shehab A. ALZOBAIDI, Spring, TX (US); Emre TURKOZ, Lambertville, NJ (US); Shreerang S. CHHATRE, The Woodlands, TX (US)

(21) Appl. No.: 18/453,024

(22) Filed: Aug. 20, 2023

Related U.S. Application Data
(60) Provisional application No. 63/380,260, filed on Oct. 20, 2022.

(51) Int. Cl. C09K 8/68; E21B 43/16; E21B 43/26

(52) U.S. Cl. CPC C09K 8/68; E21B 43/16; E21B 43/26

(57) ABSTRACT

A method of the present disclosure for fracturing a subterranean formation (e.g., an unconventional formation) may include: injecting a fracturing fluid into the subterranean formation at a pressure sufficient to hydraulically fracture the subterranean formation. Said fracturing fluid may comprise an aqueous fluid and a zwitterionic surfactant at a concentration of less than or equal to a critical micelle concentration.

### CROSS-REFERENCE TO RELATED APPLICATIONS

This application claims the benefit of U.S. Provisional Application Ser. No. 63/380,260, entitled “INJECTION AND HYDRAULIC FRACTURING FLUIDS CONTAINING ZWITTERIONIC SURFACTANTS AND RELATED METHODS,” filed Oct. 20, 2022, the disclosure of which is hereby incorporated by reference in its entirety.

### FIELD OF THE INVENTION

The present application relates to production of hydrocarbons through the use of hydraulic fracturing of subterranean formations surrounding oil wells, gas wells, and similar boreholes. The application further relates to the use of injection fluids in hydrocarbon recovery.

### BACKGROUND OF THE INVENTION

Hydraulic fracturing is a widely used stimulation technique for increasing the production of crude oil and natural gas from wells in low permeability formations. The method normally involves the formation of artificial fractures using one or more injection fluids under pressure, such as a proppant-based fracture fluid, water, or an aqueous solution. The injection of a fracturing fluid into a well is performed at a rate and pressure sufficient to propagate a fracture adjacent to the well. The injected fluid flows into the void created by the fracture of the rock and eventually diffuses into the pores of the rock exposed by the fracture. Propping agent particles suspended in the fracturing fluid may be used to maintain the fracture in a propped condition when the applied pressure is relieved.

### SUMMARY OF THE INVENTION

A nonlimiting example method of the present disclosure comprises: injecting a fracturing fluid into a subterranean formation at a pressure sufficient to hydraulically fracture the subterranean formation, wherein the fracturing fluid comprises an aqueous fluid and a zwitterionic surfactant at a concentration of less than or equal to a critical micelle concentration, and wherein the subterranean formation comprises an unconventional formation.

Another nonlimiting example method of the present disclosure comprises: injecting an injection fluid into a subterranean formation, wherein the injection fluid comprises an aqueous fluid and a zwitterionic surfactant at a concentration of less than or equal to a critical micelle concentration, and wherein the subterranean formation comprises an unconventional formation; shutting in the injection fluid; and producing hydrocarbons from the subterranean formation.

These and other features and attributes of the disclosed methods and systems of the present disclosure and their advantageous applications and/or uses will be apparent from the detailed description which follows.

### BRIEF DESCRIPTION OF THE DRAWINGS

To assist those of ordinary skill in the relevant art in making and using the subject matter hereof, reference is made to the appended drawings. The following figures are included to illustrate certain aspects of the disclosure, and should not be viewed as exclusive configurations. The subject matter disclosed is capable of considerable modifications, alterations, combinations, and equivalents in form and function, as will occur to those skilled in the art and having the benefit of this disclosure.

FIG. 1 is a photograph of exemplary imbibition cells used for testing surfactant compositions in a furnace.

FIG. 2 illustrates a graph of three exemplary zwitterionic surfactant-containing samples' recovery factor and a comparative example recovery factor.

FIG. 3 illustrates a graph of three exemplary zwitterionic surfactant-containing samples' interfacial tension in oil and a comparative example interfacial tension in oil.

FIG. 4 illustrates a prophetic comparison of relative permeability of oil and water at varying water saturation levels for a zwitterionic surfactant-containing sample and for a comparative example.

### DETAILED DESCRIPTION

The present application relates to production and recovery of hydrocarbons through the use of hydraulic fracturing fluids and/or injection fluids that comprise zwitterionic surfactants. The inclusion of a zwitterionic surfactant may increase in wettability of rock surfaces to water contacted by the zwitterionic surfactant and/or reduce the surface tension between the fluid containing the zwitterionic surfactant and the liquid hydrocarbon in the reservoir. The increased water wettability and decreased surface tension may enhance the production and recovery of hydrocarbons and may increase the stability of the fracturing fluid, injection fluid, and other fluids described herein.

Further, because zwitterionic surfactants have both a positive and negative charge head group, such surfactants may be more stable to conditions that would normally adversely affect a cationic surfactant or an anionic surfactant. Said conditions may include increased salt concentration, the presence of other additives (e.g., some polymeric additives), and the like. Accordingly, lower concentrations of zwitterionic surfactants may be included in the methods and compositions of the present disclosure to achieve enhanced production and recovery of hydrocarbons.

### Definitions

At the outset, and for ease of reference, certain terms used in this application and their meanings as used in this context are set forth. To the extent a term used herein is not defined below, it should be given the broadest definition those skilled in the art have given that term as reflected in at least one printed publication or issued patent. Further, the present techniques are not limited by the usage of the terms shown below, as all equivalents, synonyms, new developments, and terms or techniques that serve the same or a similar purpose are considered to be within the scope of the present claims.

As used herein, the term “fluid” refers to gases and liquids, as well as to combinations of gases and liquids, combinations of gases and solids, combinations of liquids and solids, and combinations of gases, liquids, and solids.

The use of the noun “fracture” refers to a crack or surface of breakage induced by an applied pressure or stress within a subsurface formation.

The use of the verb “fracture” means to perform a stimulation treatment, such as a hydraulic fracturing treatment, which is routine for hydrocarbon wells in low-permeability reservoirs. Specially-engineered fracturing fluids may be pumped at pressures and rates into the reservoir interval to be treated such that fractures may be forced open. The wings of the fractures may extend away from the wellbore in opposing directions according to the natural stresses within the formation. The characteristics of different fractures and fracture networks may have a significant impact on a reservoir's production capability.

The term “fracturing fluid” generally refers to a fluid that is injected into a hydrocarbon well as part of a stimulation operation, typically comprising a flowable fluid, proppant particulates, and one or more optional additives. “Injection fluid” generally refers to any fluid injected into a hydrocarbon well as part of any operation.

The term “hydraulic fracturing” refers to a process for creating fractures that extend from a wellbore into a reservoir, so as to stimulate the flow of hydrocarbon fluids from the reservoir into the wellbore.

A “hydrocarbon” is an organic compound that primarily includes the elements hydrogen and carbon, although nitrogen, sulfur, oxygen, metals, or any number of other elements may be present in relatively small amounts. As used herein, the term “hydrocarbon” generally refers to components found in natural gas, oil, or chemical processing facilities. Moreover, the term “hydrocarbon” may refer to components found in raw natural gas, such as CH₄, C₂H₆, C₃ isomers, C₄ isomers, benzene, and the like.

As used herein, the term “proppant particulate” or simply “proppant” refers to any suitable material that is capable of maintaining an open and induced fracture within a formation during and following a hydraulic fracturing treatment for a corresponding wellbore.

“Subterranean formation” (also referred to as “subsurface formation” or simply “formation”) refers to a subsurface region including an aggregation of subsurface sedimentary, metamorphic, and/or igneous matter, whether consolidated or unconsolidated, and other subsurface matter, whether in a solid, semi-solid, liquid, and/or gaseous state, related to the geological development of the subsurface region. A formation can be a body of geologic strata of predominantly one type of rock or a combination of types of rock, or a fraction of strata having substantially common sets of characteristics. A formation can contain one or more hydrocarbon-bearing intervals, generally referred to as “reservoirs.” Note that the terms “formation,” “reservoir,” and “interval” may be used interchangeably, but may generally be used to denote progressively smaller subsurface regions, stages, or volumes. More specifically, a “formation” may generally be the largest subsurface region, while a “reservoir” may generally be a hydrocarbon-bearing stage or interval within the geologic formation that includes a relatively high percentage of oil and gas. Moreover, an “interval” may generally be a sub-region or portion of a reservoir. In some cases, a hydrocarbon-bearing stage, or reservoir, may be separated from other hydrocarbon-bearing stages by stages of lower permeability, such as mudstones, shales, or shale-like (i.e., highly-compacted) sands.

The term “near-perforation region,” when used in reference to a fracture within a subsurface region, refers to a portion of the fracture that is within close proximity to corresponding perforation(s), such as, for example, within 5 feet, within 10 feet, within 15 feet, or within 20 feet of the perforation(s). In addition, the term “near-perforation region” may also refer to the actual perforations (or perforation tunnels) corresponding to the fracture.

The term “extended region,” when used in reference to a fracture within a subsurface region, refers to a portion of the fracture that is beyond the near-perforation region, such as the region beginning about 20 feet to about 50 feet from the corresponding perforation(s) and extending substantially the entire length of the fracture (or some substantial portion thereof, such as, for example, around 70% to around 90% of the total length of the fracture).

As used herein, the term “surface” refers to the uppermost land surface of a land well, or the mud line of an offshore well, while the term “subsurface” (or “subterranean”) refers to a geologic strata occurring below the earth's surface. Moreover, as used herein, “surface” and “subsurface” are relative terms. The fact that a particular piece of equipment is described as being on the surface does not necessarily mean it must be physically above the surface of the earth but, rather, describes only the relative placement of the surface and subsurface pieces of equipment. In that sense, the term “surface” may generally refer to any equipment that is located above the casing strings and other equipment that is located inside the wellbore. Moreover, according to embodiments described herein, the terms “downhole” and “subsurface” may be used interchangeably, although the term “downhole” is generally used to refer specifically to the inside of the wellbore.

The term “wellbore” refers to a borehole drilled into a subterranean formation. The borehole may include vertical, deviated, highly deviated, and/or horizontal sections. The term “wellbore” also includes the downhole equipment associated with the borehole, such as casing strings, production tubing, artificial/gas lift valves, and other subsurface equipment. Relatedly, the term “hydrocarbon well” (or simply “well”) includes the wellbore in addition to the wellhead and other associated surface equipment.

As used herein, the term “unconventional formation” refers to a subterranean (including subsea) formation that may contain hydrocarbons (e.g. oil, natural gas, and the like) and that has low permeability of the hydrocarbon to the wellbore. Unconventional formations generally require the use of hydraulic fracturing in order to create artificial fractures within the formation. Unconventional formations may include tight-oil bearing rocks.

“Hydraulic pressure” as used herein refers to the pressure created by the pumping of a fluid into a subterranean formation. Hydraulic pressure may be measured at the wellhead, within the subterranean formation, or any other location encapsulated by the pumping of the fluid.

“Zwitterionic” as used herein refers to a molecule having a net formal charge of zero, but negative and positive formal charges on individual atoms or functional groups within its structure.

The charged atoms or functional groups must be joined by one or more covalent bonds. “Surfactant” as used herein refers to a compound which lowers surface tension (or interfacial tension) between two liquid substances, between a liquid and a gas, or between a liquid and a solid. A “zwitterionic surfactant” as used herein refers to a surfactant which comprises molecules which are zwitterionic in nature and/or function as zwitterionic.

“Wettability” as used herein refers to the degree of adherence, or attraction of a liquid onto a solid surface (e.g. rock surface). Wettability is expressed mathematically by the contact angle (wetting angle) of the oil-water interface against the rock. This angle may depend on the degree of preferential attraction or, put another way, the work needed to separate a wetting fluid from a solid.

“Interfacial tension” refers to the interaction at the interface between a liquid phase of one substance and a solid, liquid, or gas phase of another substance. Interfacial tension determines the mixing potential and miscibility between the two substances. Interfacial tension can be measured in units of energy per unit surface area (e.g., Joules per square meter) or in units of force per unit length (e.g., Newtons per meter).

“Critical micelle concentration” is defined as the concentration of surfactants above which micelles form and all additional surfactants added to the system will form micelles in a liquid. A “micelle” refers to an aggregate of surfactant phospholipid molecules dispersed in a liquid, forming a colloidal suspension. Below the critical micelle concentration, the surfactant will generally remain dispersed within the solution of the liquid.

### Methods, Compositions, and Systems for Hydraulic Fracturing Using Zwitterionic Surfactants

The injection fluids and fracturing fluids of the present disclosure may comprise an aqueous fluid and a zwitterionic surfactant.

Examples of aqueous fluid suitable for use in the compositions and methods of the present disclosure may include, but are not limited to, fresh water (e.g., about 0 g salt/kg water to about 1 g salt/kg water), brackish water (e.g., about 1 g salt/kg water to about 30 g salt/kg water), saltwater (including seawater (e.g., about 30 g salt/kg water to about 50 g salt/kg water) and brines (e.g., about 50 g salt/kg water and greater)), the like, and any combination thereof. Sources for said aqueous fluids may include, but are not limited to, fresh water, seawater, brackish water, treated water (e.g., treated production water, treated wastewater), slickwater, produced water, other sources of aqueous fluids, the like, and any combination thereof. Because zwitterionic surfactants have both a positive and negative charge head group, such surfactants may be able to tolerate higher concentrations of salt in the aqueous fluid. For example, where aqueous fluids comprising salts are used, the salt concentration may be about 10 g salt/kg water or greater (e.g., about 10 g salt/kg water to about 80 g salt/kg water, or about 10 g salt/kg water to about 40 g salt/kg water, or about 25 g salt/kg water to about 60 g salt/kg water, or about 40 g salt/kg water to about 80 g salt/kg water). The ability to use aqueous fluids with higher salt concentrations may allow for effective use of produced water, treated produced water, higher-salinity brackish water, seawater, and brines that may be more readily available than fresh water depending on the location of the job site.

Examples of zwitterionic surfactant suitable for use in the compositions and methods of the present disclosure may include, but are not limited to, 3-[(3-cholamidopropyl)dimethylammonio]-1-propanesulfonate (CHAPS), 3-([3-cholamidopropyl]dimethylammonio)-2-hydroxy-1-propanesulfonate (CHAPSO), cocamidopropyl betaine, amidosulfobetaine-16, lauryl-N,N-(dimethyl)-glycinebetaine, lauryl-N,N-(dimethylammino)butyrate, hexadecyl phosphocholine, lauryl-N,N-(dimethyl)-propanesulfone, lauryldimethylamine N-oxide, the like, and any combination thereof.

The zwitterionic surfactant may be present in the injection fluids and fracturing fluids of the present disclosure at a concentration less than or equal to a critical micelle concentration (CMC) of said zwitterionic surfactant. The CMC of a surfactant may depend on several factors including, but not limited to, temperature, pH, salt concentration, and the like. For the purposes of the present disclosure, the CMC of the zwitterionic surfactant for a given injection fluid or fracturing fluid may be determined experimentally using tensiometery at room temperature where the concentration of the zwitterionic surfactant is altered but the remaining composition of the injection fluid or fracturing fluid is constant. Using the tensiometery data, the break point is the CMC.

The injection fluids and fracturing fluids described herein may include zwitterionic surfactants at about 0.001 wt % to about 5 wt % (or about 0.001 wt % to about 0.1 wt %, or about 0.01 wt % to about 1 wt %, or about 0.1 wt % to about 5 wt %) based on the weight of the aqueous fluid. The wt % of zwitterionic surfactant in the injection fluids and fracturing fluids may be based, at least partially, on the composition (e.g., concentration of salt) of the aqueous fluid.

The pH of the injection fluid or fracturing fluid may be adjusted using any suitable method known in the art, including the addition of an acidic and/or basic compound. The pH of the injection fluids and fracturing fluids described herein may about 4 to about 10 (or about 5 to about 9, or about 6 to about 8).

The inclusion of a zwitterionic surfactant may allow for an increase in wettability of rock surfaces within the subterranean formation, allowing for increased recovery of hydrocarbon. By increasing the wettability of the rock surfaces, the fluid may penetrate further into the rock surrounding the fractures and/or wellbore. Therefore, more hydrocarbons may be recovered and/or produced from the formation.

Wettability may be quantified using contact angle. Herein, wettability may be measured according to ASTM D5725-99(2008) using a rock substrate that is of similar composition (e.g., preferably the same composition like from a core sample) to the rock of the reservoir. The injection fluids and fracturing fluids described herein may have a contact angle with said rock of about 5° to about 85° (or about 5° to about 75°, or about 5° to about 40°, or about 5° to about 20°, or about 15° to about 50°, or about 25° to about 85°).

Additionally, the inclusion of a zwitterionic surfactant may reduce the interfacial tension of the aqueous fluid and a hydrocarbon present in the subterranean formation. Interfacial tension may be measured with a pendant drop method according to ISO 19403-3:2017 at room temperature (22° C.). The injection fluids and fracturing fluids described herein may have an interfacial tension with the hydrocarbon present in the subterranean formation of about 1 mN/m to about 70 mN/m (or about 1 mN/m to about 60 mN/m, or about 5 mN/m to about 60 mN/m, or about 5 mN/m to about 40 mN/m, or about 10 mN/m to about 40 mN/m, or about 10 mN/m to about 30 mN/m, or about 30 mN/m to about 70 mN/m, or about 40 mN/m to about 70 mN/m).

The present disclosure provides a method for injecting a fracturing fluid into a subterranean formation under hydraulic pressure at a pressure sufficient to hydraulically fracture the subterranean formation, wherein the fracturing fluid comprises an aqueous fluid and a zwitterionic surfactant, wherein the zwitterionic surfactant has a concentration in the fracturing fluid of less than or equal to a critical micelle concentration, and wherein the subterranean formation comprises an unconventional formation.

The injection fluids and fracturing fluids of the present disclosure may comprise an aqueous fluid, a zwitterionic surfactant, and additives. Examples of additives may include, but are not limited to, friction reducers (e.g., polyacrylamide), proppant (e.g., sand resin-coated sand, sintered bauxite, glass beads, and the like), biocides, fluid-loss agents, the like, and any combination thereof. The additives may be present in the injection fluids and fracturing fluids of the present disclosure at about 0.1 wt % to about 25 wt % (or about 0.1 wt % to about 5 wt %, or about 1 wt % to about 15 wt %, or about 5 wt % to about 25 wt %) based on the weight of the aqueous fluid.

As part of any method of the present disclosure, a perforation device may be positioned within a tubular conduit of a downhole tubular extending through a wellbore within a subsurface region. This may be performed in any suitable manner. The downhole tubular may be perforated using the perforation device to define (or create) perforations within the downhole tubular. This may be accomplished in any suitable manner.

The fracturing fluid may be pumped into the tubular conduit to fracture areas of the subsurface region that are proximate to the perforations, forming corresponding fractures within the subsurface region. The fracturing fluid may be pumped under hydraulic pressure at a rate and pressure sufficient to form at least one fracture in the subsurface region. For example, this may include flowing the fracturing fluid into the tubular conduit while sequentially increasing and decreasing the pumping rate, thus inducing a number of pressure cycles within the wellbore. Such pressure cycles, in turn, may help to force the fracturing fluid into the subsurface region via the perforations, locally pressurizing the subsurface region such that fractures form within the subsurface region.

A slurry including the fracturing fluid and proppant particulates may be flowed into at least a portion of the fractures, via the perforations, to prop the fractures with the proppant. In various embodiments, the propping may involve depositing the proppant within primarily the near-perforation region of the fractures.

A slurry including the fracturing fluid may be returned (or flowed back) to the wellhead of the wellbore. In various embodiments, this is accomplished by first allowing the hydraulic pressure within the wellbore to dissipate and then putting the hydrocarbon well into production.

During injection and fracturing methods, solids may precipitate within the subterranean formation in the presence of the fracturing fluid. The precipitated solids may clog pores within the formation and/or downhole equipment, thereby reducing the recovery and production of hydrocarbons. Without being bound by theory, it is believed that the charge balance of the zwitterionic surfactants mitigates the precipitation of solids during said methods.

Methods of the present disclosure may be performed during an initial fracturing operation. This initial fracturing operation may comprise hydraulic fracturing.

Methods of the present disclosure may be performed during a re-fracturing operation. Injecting of the fracturing fluid may occur as part of re-fracturing a horizontal well, which may result in increased quantity of hydrocarbon production from the horizontal well.

Methods of the present disclosure may be performed during an enhanced oil recovery operation. Injection of the injection fluid may occur as part of an enhanced oil recovery operation. The injection of the injection fluid may occur at one or more injection wells. Injection fluids may be injected as a flood injection that does not fracture the formation or may be injected with sufficient pressure to create one or more fractures in the formation.

Methods of the present disclosure may include treating a depleted well through the injection of the injection fluid, which may occur as part of an enhanced oil recovery operation. Said injection fluids may be injected as a flood injection that does not fracture the formation or may be injected with sufficient pressure to create one or more fractures in the formation.

For example, treating a depleted well (including a well with any level of depletion) may include (i) injecting an injection fluid of the present disclosure into a subterranean formation (below, at, or above pressures and rates sufficient to create one or more fractures in the formation), (ii) shutting in (or soaking) the injection fluid to allow the injection fluid to permeate through formation, and (iii) producing hydrocarbons from the formation.

During the shutting in step, the initial shut in pressure may be higher than bottomhole pressure prior to shutting in. Alternatively, the shut in pressure may be less than or equal to the bottomhole pressure prior to shutting in. The shutting in may occur for at least 1 day (or about 1 day, or at least 2 days, or about 2 days, or about 3 days, or about 4 days, or about 5 days, or at least 5 days). Without being bound by theory, the shut in time (or soaking period) may be dependent on the specific chemistry and concentration of the zwitterionic surfactant used, interactions with specific rock surface types, shut in pressure, and/or amount of injection fluid used.

The above described methods for treating a depleted well may be used in any combination with other enhanced oil recovery techniques, including cyclic steam injection, cyclic CO 2 injection, and other suitable methods known in the art.

### Additional Embodiments

Embodiment 1. A method comprising: injecting a fracturing fluid into a subterranean formation at a pressure sufficient to hydraulically fracture the subterranean formation, wherein the fracturing fluid comprises an aqueous fluid and a zwitterionic surfactant at a concentration of less than or equal to a critical micelle concentration, and wherein the subterranean formation comprises an unconventional formation.

Embodiment 2. The method of Embodiment 1, wherein the zwitterionic surfactant has a concentration in the fracturing fluid of about 0.001 wt % to about 5 wt % by weight of the aqueous fluid.

Embodiment 3. The method of any one of Embodiments 1-2, wherein a source of the aqueous fluid includes one or more of: fresh water, brackish water, saltwater, treated water, slickwater, and produced water.

Embodiment 4. The method of any one of Embodiments 1-3, wherein the zwitterionic surfactant comprises one or more of: 3-[(3-cholamidopropyl)dimethylammonio]-1-propanesulfonate (CHAPS), 3-([3-cholamidopropyl]dimethylammonio)-2-hydroxy-1-propanesulfonate (CHAPSO), cocamidopropyl betaine, amidosulfobetaine-16, lauryl-N,N-(dimethyl)-glycinebetaine, lauryl-N,N-(dimethylammino)butyrate, hexadecyl phosphocholine, and lauryl-N,N-(dimethyl)-propanesulfone, lauryldimethylamine N-oxide.

Embodiment 5. The method of any one of Embodiments 1-4, wherein the injecting is performed during an initial fracturing operation.

Embodiment 6. The method of any one of Embodiments 1-5, wherein the injecting is performed during an enhanced oil recovery operation.

Embodiment 7. The method of any one of Embodiments 1-6, further comprising shutting in the fracturing fluid after the injecting.

Embodiment 8. The method of Embodiment 7, wherein the shutting in is for at least one day.

Embodiment 9. The method of any one of Embodiments 1-8, further comprising adjusting a pH of the fracturing fluid prior to the injecting.

Embodiment 10. The method of any one of Embodiments 1-9, wherein an interfacial tension between the fracturing fluid and a hydrocarbon present in the subterranean formation is from about 1 mN/m to about 70 mN/m.

Embodiment 11. The method of any one of Embodiments 1-10, wherein a contact angle of the fracturing fluid with the subterranean formation is between 5° and 85°.

Embodiment 12. A method comprising: injecting an injection fluid into a subterranean formation, wherein the injection fluid comprises an aqueous fluid and a zwitterionic surfactant at a concentration of less than or equal to a critical micelle concentration, and wherein the subterranean formation comprises an unconventional formation; shutting in the injection fluid; and producing hydrocarbons from the subterranean formation.

Embodiment 13. The method of Embodiment 12, wherein the injecting occurs at a rate and pressure sufficient to create at least one fracture in the subterranean formation.

Embodiment 14. The method of any one of Embodiments 12-13, wherein the zwitterionic surfactant has a concentration in the injection fluid of about 0.001 wt % to about 5 wt % by weight of the aqueous fluid.

Embodiment 15. The method of any one of Embodiments 12-14, wherein a source of the aqueous fluid includes one or more of: fresh water, brackish water, saltwater, treated water, slickwater, and produced water.

Embodiment 16. The method of any one of Embodiments 12-15, wherein the zwitterionic surfactant comprises one or more of: 3-[(3-cholamidopropyl)dimethylammonio]-1-propanesulfonate (CHAPS), 3-([3-cholamidopropyl]dimethylammonio)-2-hydroxy-1-propanesulfonate (CHAPSO), cocamidopropyl betaine, amidosulfobetaine-16, lauryl-N,N-(dimethyl)-glycinebetaine, lauryl-N,N-(dimethylammino)butyrate, hexadecyl phosphocholine, and lauryl-N,N-(dimethyl)-propanesulfone, lauryldimethylamine N-oxide.

Embodiment 17. The method of any one of Embodiments 12-16, wherein the shutting in is for at least one day.

Embodiment 18. The method of any one of Embodiments 12-17, further comprising adjusting a pH of the injection fluid prior to the injecting.

Embodiment 19. The method of any one of Embodiments 12-18, wherein an interfacial tension between the injection fluid and a hydrocarbon present in the subterranean formation is from about 1 mN/m to about 70 mN/m.

Embodiment 20. The method of any one of Embodiments 12-19, wherein a contact angle of the injection fluid with the subterranean formation is between 5° and 85°.

Unless otherwise indicated, all numbers expressing quantities of ingredients, properties such as molecular weight, reaction conditions, and so forth used in the present specification and associated claims are to be understood as being modified in all instances by the term “about.” Accordingly, unless indicated to the contrary, the numerical parameters set forth in the following specification and attached claims are approximations that may vary depending upon the desired properties sought to be obtained by the incarnations of the present inventions. At the very least, and not as an attempt to limit the application of the doctrine of equivalents to the scope of the claim, each numerical parameter should at least be construed in light of the number of reported significant digits and by applying ordinary rounding techniques.

One or more illustrative incarnations incorporating one or more invention elements are presented herein. Not all features of a physical implementation are described or shown in this application for the sake of clarity. It is understood that in the development of a physical embodiment incorporating one or more elements of the present invention, numerous implementation-specific decisions must be made to achieve the developer's goals, such as compliance with system-related, business-related, government-related and other constraints, which vary by implementation and from time to time. While a developer's efforts might be time consuming, such efforts would be, nevertheless, a routine undertaking for those of ordinary skill in the art and having benefit of this disclosure.

While compositions and methods are described herein in terms of “comprising” various components or steps, the compositions and methods can also “consist essentially of” or “consist of” the various components and steps.

To facilitate a better understanding of the embodiments of the present invention, the following examples of preferred or representative embodiments are given. In no way should the following examples be read to limit, or to define, the scope of the invention.

### Examples

Example 1. Spontaneous imbibition cells were prepared by obtaining rock cores from various hydrocarbon producing regions. The rock cores were pre-saturated with a volume of oil (specifically, Midland crude). Brine mixed with zwitterionic surfactant was premixed and used to fill the imbibition cells.

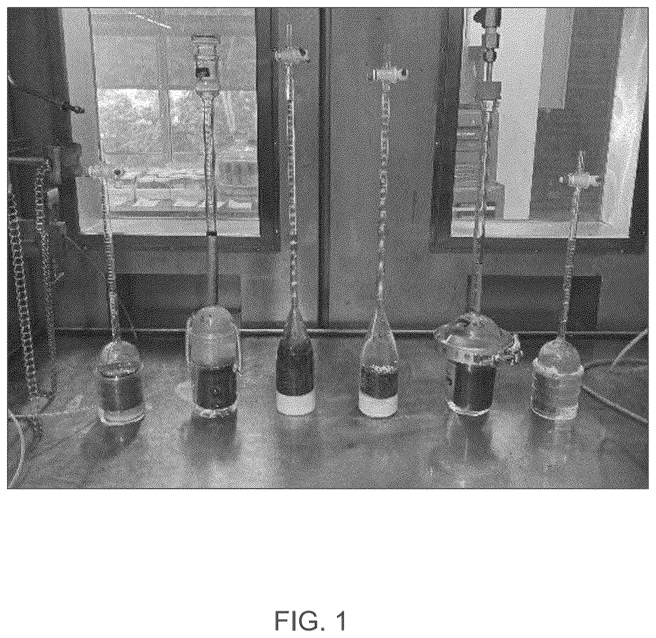

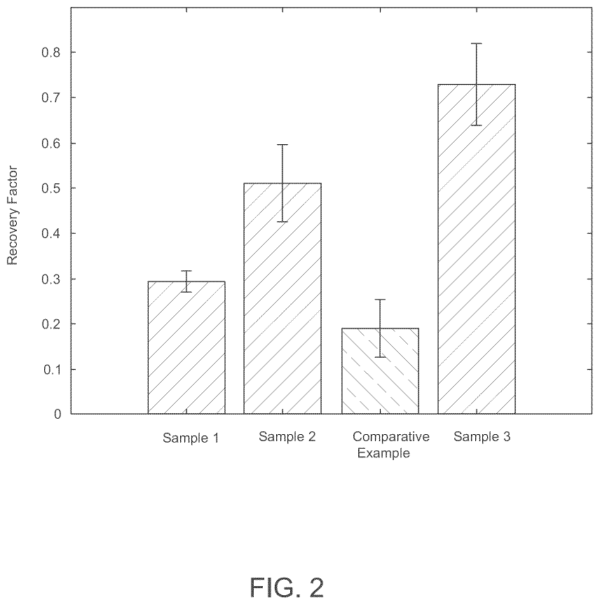

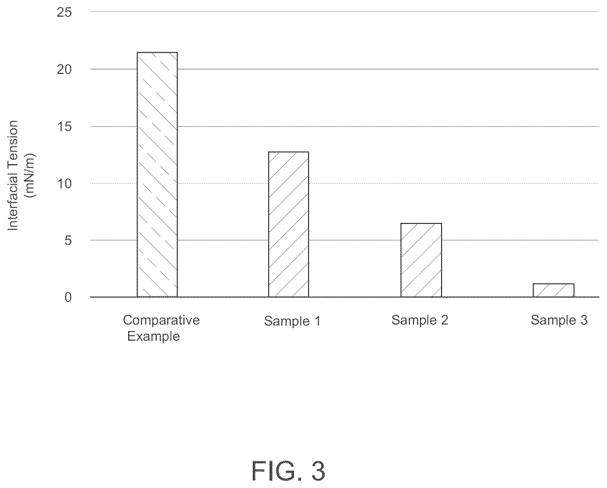

Imbibition cells were placed in a furnace at 80° C. for 1 week in order to mimic reservoir temperatures. FIG. 1 is a photograph of imbibition cells after baking in the furnace. The cells were subsequently tested for recovery factor. Recovered oil volume was measured using notches in the top portion of the imbibition cells. Recovery factor was calculated by dividing the recovered oil volume by the volume of oil originally pre-saturated into the rock cores. FIG. 2 shows a graph demonstrating an increase in recovery factor over the Comparative Example (no surfactant) for in Sample 1 (zwitterionic surfactant, available from Verde, headquartered in Midland, TX), Sample 2 (zwitterionic surfactant, available from Championx, headquartered in The Woodlands, TX), and Sample 3 (zwitterionic surfactant, available from Verde, headquartered in Midland, TX). The cells were tested for interfacial tension of the oil in relation to the aqueous fluid in the imbibition cells. Interfacial tension was measured using the pendant drop method. The results of interfacial tension testing are shown in FIG. 3.

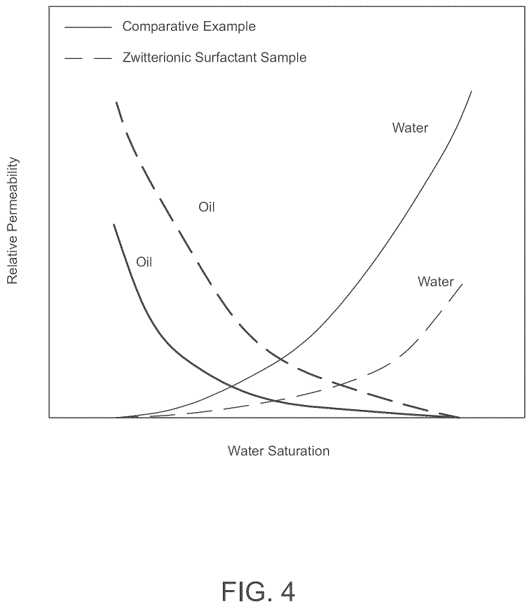

Example 2. In a prophetic example, an unconventional hydrocarbon-producing formation is fractured with a control brine free of surfactants and, separately, fractured with a zwitterionic surfactant-added brine. Rock samples are taken from the formation and are tested for relative permeability. The relative permeability is tested with core-flooding units by measuring steady-state permeability. FIG. 4 shows permeability curves of oil and water of rock samples, demonstrating the results of relative permeability testing. This example illustrates that with the addition of zwitterionic surfactant, water saturation increases, resulting in a more water-wet rock, which may lead to improved hydrocarbon production capability.

Therefore, the present invention is well adapted to attain the ends and advantages mentioned as well as those that are inherent therein. The particular examples and configurations disclosed above are illustrative only, as the present invention may be modified and practiced in different but equivalent manners apparent to those skilled in the art having the benefit of the teachings herein. Furthermore, no limitations are intended to the details of construction or design herein shown, other than as described in the claims below. It is therefore evident that the particular illustrative examples disclosed above may be altered, combined, or modified and all such variations are considered within the scope and spirit of the present invention. The invention illustratively disclosed herein suitably may be practiced in the absence of any element that is not specifically disclosed herein and/or any optional element disclosed herein. While compositions and methods are described in terms of “comprising,” “containing,” or “including” various components or steps, the compositions and methods can also “consist essentially of” or “consist of” the various components and steps. All numbers and ranges disclosed above may vary by some amount. Whenever a numerical range with a lower limit and an upper limit is disclosed, any number and any included range falling within the range is specifically disclosed. In particular, every range of values (of the form, “from about a to about b,” or, equivalently, “from approximately a to b,” or, equivalently, “from approximately a-b”) disclosed herein is to be understood to set forth every number and range encompassed within the broader range of values. Also, the terms in the claims have their plain, ordinary meaning unless otherwise explicitly and clearly defined by the patentee. Moreover, the indefinite articles “a” or “an,” as used in the claims, are defined herein to mean one or more than one of the element that it introduces.

What is claimed is:

1. A method comprising:
injecting a fracturing fluid into a subterranean formation at a pressure sufficient to hydraulically fracture the subterranean formation, wherein the fracturing fluid comprises an aqueous fluid and a zwitterionic surfactant at a concentration of less than or equal to a critical micelle concentration, and wherein the subterranean formation comprises an unconventional formation.

2. The method of claim 1, wherein the zwitterionic surfactant has a concentration in the fracturing fluid of about 0.001 wt % to about 5 wt % by weight of the aqueous fluid.

3. The method of claim 1, wherein a source of the aqueous fluid includes one or more of: fresh water, brackish water, saltwater, treated water, slickwater, and produced water.

4. The method of claim 1, wherein the zwitterionic surfactant comprises one or more of: 3-[(3-cholamidopropyl)dimethylammonio]-1-propanesulfonate (CHAPS), 3-([3-cholamidopropyl]dimethylammonio)-2-hydroxy-1-propanesulfonate (CHAPSO), cocamidopropyl betaine, amidosulfobetaine-16, lauryl-N,N-(dimethyl)-glycinebetaine, lauryl-N,N-(dimethylammino)butyrate, hexadecyl phosphocholine, and lauryl-N,N-(dimethyl)-propanesulfone, lauryldimethylamine N-oxide.

5. The method of claim 1, wherein the injecting is performed during an initial fracturing operation.

6. The method of claim 1, wherein the injecting is performed during an enhanced oil recovery operation.

7. The method of claim 1, further comprising shutting in the fracturing fluid after the injecting.

8. The method of claim 7, wherein the shutting in is for at least one day.

9. The method of claim 1, further comprising adjusting a pH of the fracturing fluid prior to the injecting.

10. The method of claim 1, wherein an interfacial tension between the fracturing fluid and a hydrocarbon present in the subterranean formation is from about 1 mN/m to about 70 mN/m.

11. The method of claim 1, wherein a contact angle of the fracturing fluid with the subterranean formation is between 5° and 85°.

12. A method comprising:
injecting an injection fluid into a subterranean formation, wherein the injection fluid comprises an aqueous fluid and a zwitterionic surfactant at a concentration of less than or equal to a critical micelle concentration, and wherein the subterranean formation comprises an unconventional formation;
shutting in the injection fluid; and
producing hydrocarbons from the subterranean formation.

13. The method of claim 12, wherein the injecting occurs at a rate and pressure sufficient to create at least one fracture in the subterranean formation.

14. The method of claim 12, wherein the zwitterionic surfactant has a concentration in the injection fluid of about 0.001 wt % to about 5 wt % by weight of the aqueous fluid.

15. The method of claim 12, wherein a source of the aqueous fluid includes one or more of: fresh water, brackish water, saltwater, treated water, slickwater, and produced water.

16. The method of claim 12, wherein the zwitterionic surfactant comprises one or more of: 3-[(3-cholamidopropyl)dimethylammonio]-1-propanesulfonate (CHAPS), 3-([3-cholamidopropyl]dimethylammonio)-2-hydroxy-1-propanesulfonate (CHAPSO), cocamidopropyl betaine, amidosulfobetaine-16, lauryl-N,N-(dimethyl)-glycinebetaine, lauryl-N,N-(dimethylammino)butyrate, hexadecyl phosphocholine, and lauryl-N,N-(dimethyl)-propanesulfone, lauryldimethylamine N-oxide.

17. The method of claim 12, wherein the shutting in is for at least one day.

18. The method of claim 12, further comprising adjusting a pH of the injection fluid prior to the injecting.

19. The method of claim 12, wherein an interfacial tension between the injection fluid and a hydrocarbon present in the subterranean formation is from about 1 mN/m to about 70 mN/m.

20. The method of claim 12, wherein a contact angle of the injection fluid with the subterranean formation is between 5° and 85°.
